(19) United States
(12) Patent Application Publication
(10) Pub. No.: US 2002/0044067 A1
(43) Pub. Date: Apr. 18, 2002

(54) MESSAGE DELIVERY BASED UPON GEOGRAPHICAL AND TEMPORAL PARAMETERS

(75) Inventor: KEVIN ILCISIN, BEAVERTON, OR (US)

Correspondence Address: MARTIN C FLIESLER, FLIESLER DUBB MEYER & LOVEJOY LP, FOUR EMBARCADERO CENTER SUITE 400, SAN FRANCISCO, CA, 941114156

(73) Assignee: TECHNICAL VISIONS, INC.

(21) Appl. No.: 08/741,693

(22) Filed: Oct. 31, 1996

(51) Int. Cl. H04Q 7/00

(52) U.S. Cl. 340/825.49; 370/314; 455/421

(57) ABSTRACT

A message system includes a message delivery device having a rendering device and a locating device for determining an indication of geographical location of the display. The message system also includes a capability for selecting or generating a message for the display from among a set of predefined or generated messages in response to the indication of geographical location and a timing parameter.

### BACKGROUND OF THE INVENTION

1. Field of Invention

The present invention pertains to the field of message delivery systems. More particularly, this invention relates to a system that delivers messages based upon geographical and temporal parameters.

2. Art Background

Entities such as corporations, public organizations, or individuals commonly seek to deliver particular messages to a relatively large audience of people. Prior techniques for delivering messages to a large audience include broadcast media advertising on television and radio. Other prior techniques include newspapers, fixed location and content displays such as billboards, and fixed content mobile displays attached to vehicles such as taxicab vehicles or urban transport buses.

In addition, recent increases in the cost of broadcast advertising as well as newspaper advertising have created a demand for message delivery techniques that are able to reach specialized audiences. As a consequence, it would be desirable to employ mobile delivery systems such as signs or speakers attached to buses or taxicabs to conduct messages to specialized audiences such as individuals located in particular areas of a city.

The effectiveness of a mobile message targeted for such specialized audiences typically depends upon both geographical and temporal parameters. For example, a mobile advertising sign attached to a bus or taxicab is more effective for reaching an intended audience if displayed during peak commuting time intervals and in an appropriate geographical area targeted by the particular message.

Unfortunately, existing mobile message displays usually do not account for such geographical and temporal parameters. Taxicabs, for example, can roam over a wide area and thus could be rendered ineffective for displaying advertisements targeted for a particular neighborhood. City buses usually offer similar uncertainties in time and location of display. Moreover, such uncertainties in the actual geographical and temporal parameters associated with a particular message usually complicates the task of assessing the value of such advertising and results in imprecise customer billing for such mobile message displays.

### SUMMARY AND OBJECTS OF THE INVENTION

One object of the present invention is to provide a system with message delivery based upon geographical and temporal parameters.

Another object of the present invention is to provide a basis for accounting and billing that includes actual geographical and temporal parameters associated with delivered messages.

These and other objects are provided by a message system having a message rendering device and having a locating device for determining an indication of geographical location of the message rendering device. The message system includes a capability to select a particular message for rendering from among a set of predefined messages in response to the indication of geographical location and a timing parameter.

Other objects, features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 illustrates a message system including a message sourcing center and a mobile message delivery device and a communication link;

FIG. 2 illustrates a message selection and delivery process that accounts for geographical and temporal parameters of the message delivery devices;

FIG. 3 illustrates one embodiment of a message sourcing center;

FIG. 4 illustrates one embodiment of a message delivery device that employs a global positioning system (GPS) to obtain geographic location parameters;

FIG. 5 illustrates an embodiment of a message delivery device that employs cellular communication for geographical locating and communication;

FIG. 6 illustrates a geographical locating function of the message system that employs a cellular telephone network for locating;

FIG. 7 illustrates a process by which the message sourcing center obtains the geographical location of the message delivery device in an embodiment that employs a cellular telephone network as a geographical locating mechanism;

FIG. 8 illustrates another process by which the message sourcing center obtains the geographical location in an embodiment that employs a cellular telephone network for geographical locating.

### DETAILED DESCRIPTION

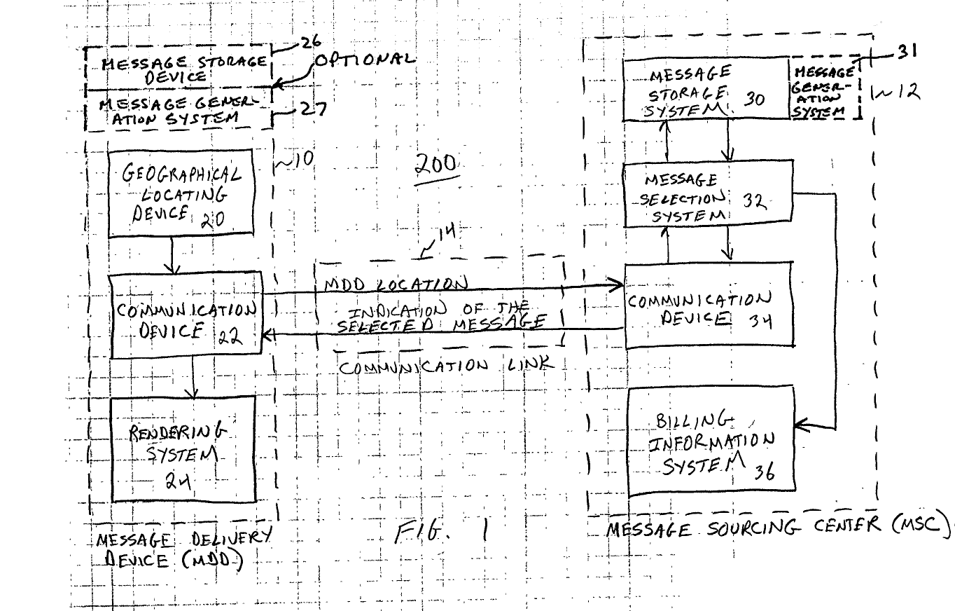

FIG. 1 illustrates a message system 200 that provides message delivery based on geographical and temporal parameters. The message system 200 includes a message sourcing center (MSC) 12 and one or more mobile message delivery devices which include for purposes of illustration a message delivery device (MDD) 10. The message sourcing center 12 communicates with the message delivery device 10 via a communication link 14.

The message delivery device 10 includes a capability for determining its geographical location. In one embodiment, the message delivery device 10 reports its geographical location to the message sourcing center 12 by transferring messages to the message sourcing center 12 via the communication link 14. The message sourcing center 12 in turn uses the reported geographical location of the message delivery device 10 in conjunction with time of day parameters to select [or generate] a particular customer defined message for rendering by the message delivery device 10. Alternatively, the message delivery device 10 internally implements logic for selecting [or generating] messages based upon its geographical location and time of day.

In one embodiment, the message sourcing center 12 transfers a selected [or generated] message from among customer defined messages to the message delivery device 10 via the communication link 14. The message delivery device 10 then renders the selected [or generated] message to an audience.

Alternatively, the message sourcing center 12 transfers an identifier for the selected [or generated] customer defined message to the message delivery device 10 via the communication link 14. The message delivery device 10 uses the identifier for the selected message to retrieve [or generate] the selected message from internal storage.

The customer defined messages may be transmitted from the message sourcing center 12 to the message delivery device 10 during off peak time periods of the communication link 14. In addition, the customer defined messages may be stored in a persistent medium within the message delivery device 10. In either case, the message sourcing center 12 need only transmit a relatively brief identifier rather than a full message which can lower the cost of message delivery during peak time periods of the communication link 14.

In yet another embodiment, the message sourcing center 12 broadcasts customer defined messages or identifiers for the customer defined messages along with corresponding selection parameters to all message delivery devices. Each message delivery device including the message delivery device 10 stores the broadcast information and then compares the selection parameters provided by the message sourcing center 12 to its geographical location and time of day to select or generate a particular customer defined message for rendering. In this embodiment, the message delivery device 10 includes a timer device to determine the time of day.

The message delivery device 10 as illustrated includes a geographical locating device 20, a communication device 22, a rendering system 24, and may have a message storage 26 or generation system 27 as well. The rendering system 24 provides audio and/or visual message rendering. The geographical locating device 20 determines the geographical location of the message delivery device 10. The optional message storage or generation unit can store or generate messages without communicating with the message sourcing center 12.

In one embodiment, the geographical locating device 20 determines location of the message delivery device 10 in response to paging or polling messages that originate with the message sourcing center 12.

In another embodiment, the geographical locating device 20 periodically determines the geographical location of the message delivery device 10 according to a predetermined time interval.

In yet another embodiment, the geographical locating device 20 independently determines and reports any significant changes in geographical location of the message delivery device 10.

The communication device 22 enables data communication over the communication link 14. The communication device 22 transfers geographical location parameters to the message sourcing center 12 via the communication link 14 in some embodiments. The communication device 22 receives data containing customer defined or generated messages or message identifiers and possibly selection parameters from the message sourcing center 12 via the communication link 14 in some embodiments.

The rendering system 24 delivers the selected or generated customer defined messages to an audience in response to the geographical location of the message delivery device 10 and temporal parameters. For applications wherein the message delivery device 10 is attached to a moving vehicle such as a city bus or a taxicab, the rendering system 24 may be selected for characteristics such as ruggedness, low power consumption, and relatively low weight. An example of such an embodiment for the rendering system 24 is a large area light emitting diode (LED) display.

The rendering system 24 may also be embodied in a wide variety of commonly available displays. For example, the rendering system 24 may have the capability to render customer defined or generated static or moving images. A raster display for example with appropriate rendering processor hardware may be employed for rendering recorded or digitally encoded video images from a number of available formats.

It is preferable that video images containing customer defined or generated messages be stored or generated within the message delivery device 10. In such embodiments, the message sourcing center 12 need only transmit a low bandwidth message identifier to the message delivery device 10 to provide real time video message delivery. In other embodiments, the communication link 14 must provide sufficient bandwidth to handle the transfer of digitally encoded video image files to provide real time message delivery.

The message sourcing center 12 includes a message storage system 30 or generation system 31, a message selection system 32, a communication device 34, and a billing information system 36. The message storage or generation system 30/31 holds a set of customer defined, customer provided, or customer generated messages for display on the rendering system 24 according to the customer defined and provided geographical and temporal parameters associated with the messages.

The customer defined or generated messages and selection parameters may be transmitted to the message sourcing center 12 via the communication link 14. Alternatively, the customer defined or generated messages and selection parameters may be provided by an off-line delivery means such as removable storage or hard copy or by alternative communication lines such as telephone land lines or cellular links.

The message selection system 32 in one embodiment selects or generates an appropriate customer defined message for delivery to an audience via the message delivery device 10. The message selection system 32 selects a particular stored or generated message based upon the customer provided geographical and temporal selection parameters for the particular message and the actual geographical parameters reported by the message delivery device 10 and the time of day. In an alternative embodiment, the message selection logic of the message selection system 32 is implemented in the message delivery device 10.

The communication device 34 enables the transfer of customer defined or generated messages to the message delivery device 10 via the communication link 14. The communication device 34 also enables the transfer of identifiers for the selected customer defined or generated messages and selection parameters as well as reception of geographical locating parameters from the message delivery device 10 as required for particular embodiments.

The billing information system 36 stores a set of billing log parameters that enable accounting and billing functions associated with the customer defined or generated messages supported by the message sourcing center 12. The billing information system 36 stores the geographical and temporal parameters associated with messages selected by the message selection system 32 and then rendered on message delivery devices supported by the message sourcing center 12 including the message delivery device 10.

In one embodiment, the communication link 14 is a conventional and commonly available cellular telephone network. In this embodiment, the communication devices 22 and 34 provide cellular modem capabilities.

In another embodiment, the communication link 14 is realized with a dedicated radio frequency spectrum for communication among the message sourcing center 12 and associated message delivery devices. In this embodiment, the communication devices 22 and 34 provide radio transceiver capabilities for the dedicated spectrum along with message encoding and decoding capabilities.

In another embodiment, the communication link 14 is provided by existing satellite communication links. In this embodiment, the communication devices 22 and 34 provide suitable uplink and downlink communication capabilities for the particular satellite system employed with the message system 200.

In another embodiment, the communication link represents the transfer through a physical means, such as a temporary cable or link, or the physical transfer of a removable storage device which contains messages, identifiers or billing information.

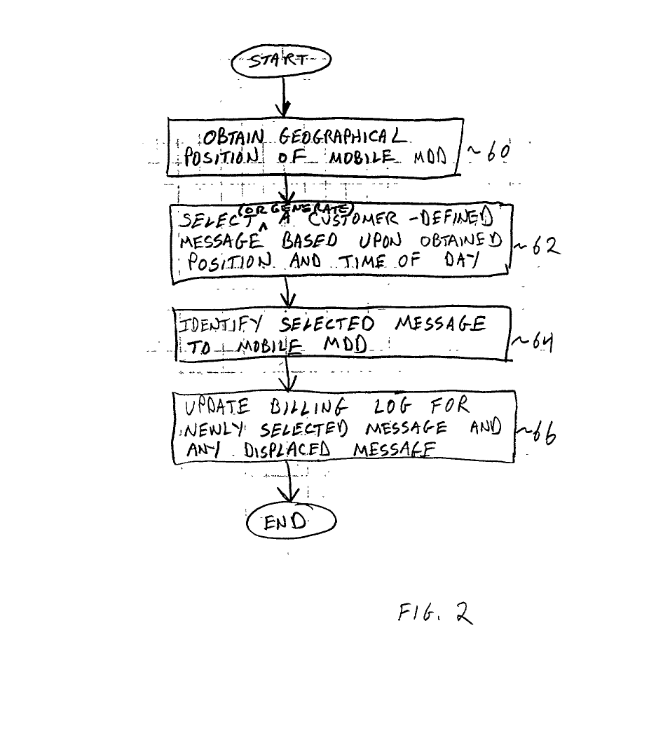

FIG. 2 illustrates a message selection or generation and display process undertaken within the message system 200. At block 60, the message sourcing center 12 obtains the geographical position of the message delivery device 10.

In one embodiment, the message sourcing center 12 obtains the geographical position of the message delivery device 10 at block 60 by transmitting a polling message via the communication link 14. The message delivery device 10 determines its current geographical position in response to the polling message from the message sourcing center 12. The message delivery device 10 then transmits its current geographical location back to the message sourcing center 12.

In another embodiment, the message delivery device 10 periodically determines its location and reports its location to the message sourcing center 12 via the communication link 14 at block 60. In yet another embodiment, the message delivery device 10 reports a significant change in its geographical location at block 60.

At block 62, the message sourcing center 12 selects a customer-defined or generated message based upon the reported geographical location parameter of the message delivery device 10 and a time of day parameter. The message sourcing system 12 selects or generates a particular message by comparing the reported geographical and time parameters of the message delivery device 10 with customer provided geographical and time selection parameters for the particular message.

At block 64, the message sourcing center 12 identifies the selected message to the message delivery device 10. In one embodiment at block 64, the message sourcing center 12 transmits the selected customer defined or generated message to the message delivery device 10 via the communication link 14. In another embodiment at block 64, the message sourcing center 12 determines a message identifier for the selected customer defined or generated message and transmits the message identifier to the message delivery device 10 via the communication link 10.

At block 66, the message sourcing center 12 updates the billing information system 36 with the geographical and temporal parameters for the newly selected message displayed on the message delivery device 10. In addition, the billing information system 36 updates the billing log parameters associated with the message displaced from the message delivery device 10 by the newly selected message.

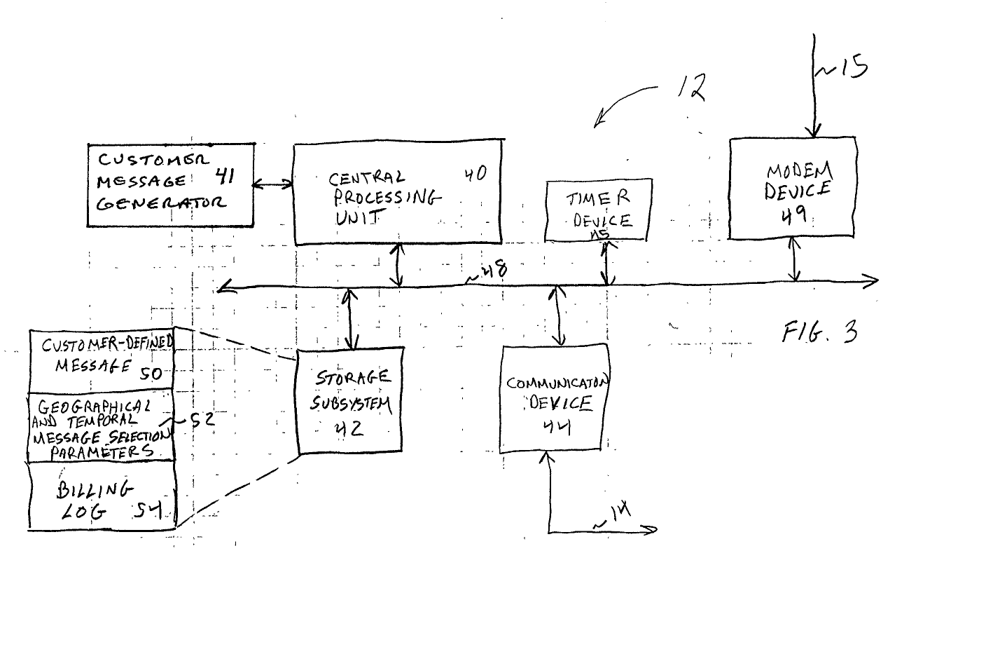

FIG. 3 illustrates one embodiment of the message sourcing center 12. The message sourcing center in this embodiment includes a central processing unit 40, a storage subsystem 42, a communication device 44 a timer device 45, and a modem device 49.

The central processing unit 40 executes a set of software that performs the message selection functions and the geographical and temporal parameter logging described above. In one embodiment, the central processing unit 40 implements a timer function in conjunction with the timer device 45 to determine time of day parameters for message selection and billing information logging. The timer device function may in some embodiments be incorporated with the central processing unit 40.

The central processing unit 40 transfers information via the communication link 14 through a communication device 44. In one embodiment, the communication device 44 is a cellular modem.

In another embodiment, the communication device 44 is a conventional modem that connects to landline based communication links which in turn are connected to a cellular telephone network for ultimate access to the message delivery device 10.

In yet another embodiment, the communication device 44 comprises a dedicated radio transceiver with a frequency spectrum allocated for communication within the message system 200. In another embodiment, the communication device 44 comprises satellite uplink and downlink circuitry for communication via a satellite system (not shown).

The storage subsystem 42 accommodates a set of customer-defined messages for delivery by one or more message delivery devices. The storage subsystem 42 also includes the customer defined geographical and time selection parameters for message selection by the message selection software executed by the central processing unit 40. In one embodiment, the customer defined messages and selection parameters are received via a telephone line 15 through a modem device 49. In addition, the storage subsystem 42 accommodates a billing log that indicates actual times and locations of message display for each of the customer defined messages.

In the example shown, the storage subsystem 42 contains a customer-defined message 50 along with its corresponding geographical and temporal message selection parameters 52 and a corresponding billing log 54. The storage subsystem 42 accommodates similar information for each of the customer defined messages of the message display system 200.

In some embodiments, there is also implemented a customer message generator. This device may be implemented as a software routine in the central processing unit 40, or as a separate hardware and software device that communicates with the central processing unit 40. Such a device allows for changes or improvements to the customer defined message. For example, a customer defined message 50 located in the storage subsystem 42, could be combined with time of day information so that the rendered message would be a combination of stored and generated information.

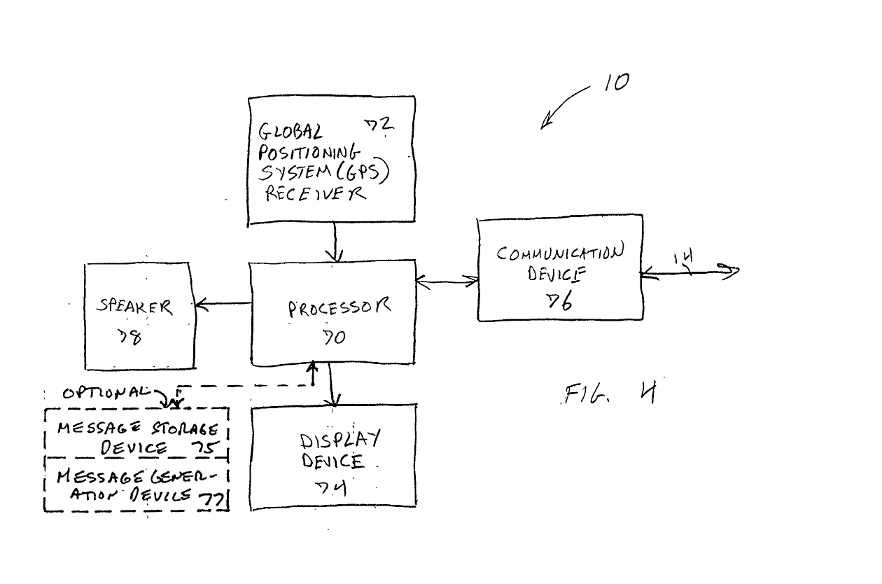

FIG. 4 illustrates one embodiment of the message delivery device 10. In this embodiment, the message delivery device 10 includes a processor 70, a global positioning system (GPS) receiver 72, a display device 74 and/or a speaker 78, a communication device 76, and may optionally include a message storage device 75 and/or a message generation device 77. In some embodiments, the processor implements a timing function. In other embodiments, timing may be provided by a timer device (not shown) within the message delivery device 10. The communication device 76 provides communication link functions and the GPS receiver 72 provides geographical locating functions.

The processor 70 receives polling messages from the message sourcing center 12 via the communication device 76 and the communication link 14. The processor 70 obtains geographical location parameters from the GPS receiver 72 in response to a polling message and then reports the geographical location parameters to the message sourcing center 12 via the communication link 14. Once the message sourcing center selects a customer defined or generated message, the processor 70 renders the selected message onto the display device 74 or through the speaker 78 or both.

The GPS receiver 72 receives and processes signals generated by the GPS satellite system. The GPS satellite system (not shown) provides satellite signals for global position determination. The GPS system is part of a satellite-based navigation system developed by the United States Defense Department. The GPS system includes a set of satellites dispersed around circular orbits. The orbits have radii of 26,560 kilometers and are approximately circular. Theoretically, three or more GPS satellites are visible from most points on the surface of the earth. As a consequence, a line of site access between the GPS receiver 72 and three or more of the GPS satellites enables determination of the geographical position of the message delivery device 10.

Each GPS satellite carries a clock to provide timing information for the signals transmitted by the satellites. Each GPS satellite transmits two L-band carrier signals, L1 and L2, which are integral multiples of a base frequency. The L1 and L2 signals from each satellite are binary phase shift key (BPSK) modulated by predetermined pseudo random noise (PRN) codes that are different for each of the GPS satellites deployed.

The PRN codes from multiple GPS satellite signals enables the GPS receiver 72 to determine the geographical position of the message delivery device 10. The GPS receiver 72 selects a particular GPS signal transmitted by a particular GPS satellite by generating and matching or correlating the PRN code for that particular satellite. All PRN codes are known and are stored in the GPS receiver 72.

The GPS satellite bit stream includes information on the ephemeris of each GPS satellite, parameters identifying the particular GPS satellite, and corrections for ionospheric signal propagation delays. A discussion of the GPS system and techniques for obtaining position information from the satellite signals is found in Guide to GPS Positioning, edited by David Wells, Canadian GPS Associates, 1986.

In another embodiment, where the optional message storage or generation device is located within the message delivery device 10, the message delivery device can, in response to polling requests or predetermined time or location change information, select or generate a message for rendering on the display device 74 without communicating with the message sourcing center. At a later time, the message delivery device can transfer, via the communication device 76 and over the communication link 14, information relevant to billing to the message sourcing center.

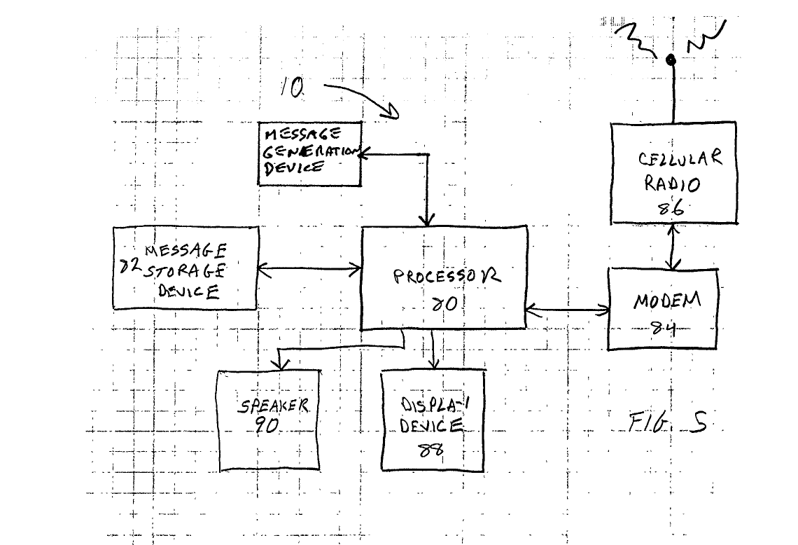

FIG. 5 illustrates another embodiment of the message delivery device 10. In this embodiment, the communication functions are realized by a modem 84 in conjunction with a cellular radio 86. In addition, the cellular radio 86 in the context of a cellular telephone network provides both the function of the communication link 14 and the geographical locating device 20.

Also included in this embodiment of the message delivery device 10 is a message storage device 82 and/or a message generation device 83. The message storage device 82 enables storage of a set of customer-defined messages for display on a display device 88 or for playback through a speaker 90. The message generation device 83 enables generation of customer messages including combinations of stored and generated messages. The message generation device 83 may be incorporated into the processor 80. The message sourcing center 12 in one embodiment transfers the set of customer-defined messages to the message delivery device 10 during off-peak and relatively low cost time intervals on the cellular network. Thereafter, the message sourcing center 12 transmits a message identifier rather than a particular selected message to the message delivery device 10 to specify particular messages. A processor 80 uses the message identifier to retrieve the selected message from the message storage device 82 or to generate the selected message with the generation device 83 and then renders the message on the display device 88.

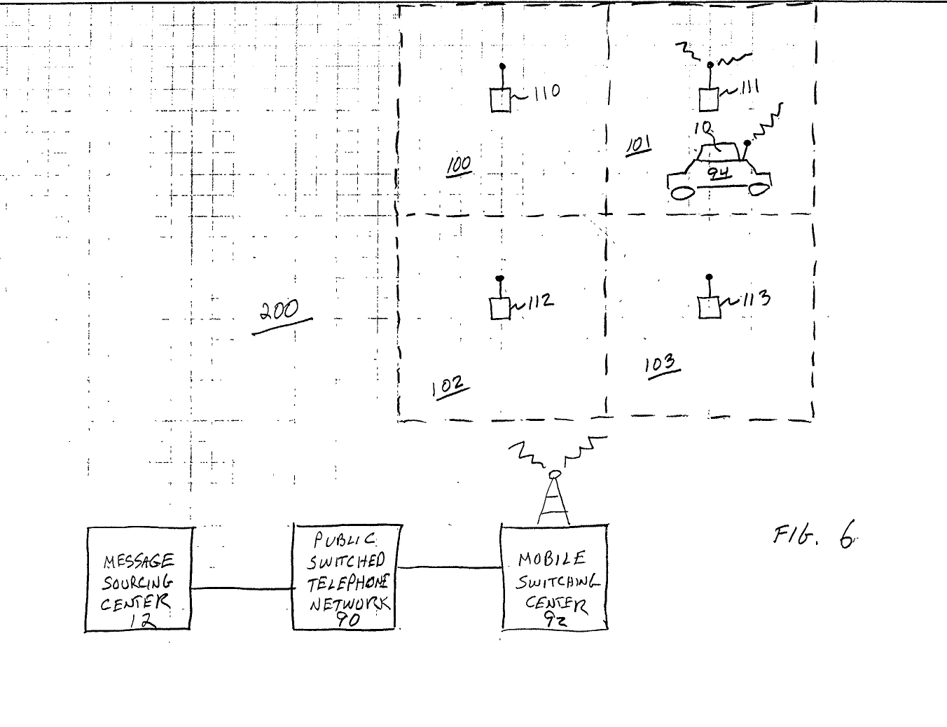

FIG. 6 illustrates the message system 200 including a cellular telephone network that provides geographical locating functions. A cellular telephone network is illustrated in simplified form having a set of cell site areas 100-103. Each cell site area 100-103 is depicted for simplicity as a rectangular area with well-defined boundaries between adjacent cell site areas.

The cellular telephone network includes a mobile switching center 92 and a set of cell site base stations 110-113 that enable communication among cellular telephone devices located within the cell site areas 100-103. Each of the cell site base stations 110-113 performs paging functions for locating and communicating with individual cellular telephones within the corresponding cell site area. In this example, a taxicab 94 is shown with the message delivery device 10 attached thereto including the cellular radio 86 described above. The taxicab 94 is shown located within the cell site area 101.

The mobile switching center 92 in conjunction with the cell site base stations 110-113 provide functions for locating and tracking and handing off individual cellular telephones that traverse across the cell site areas 100-103. The message system 200 employs these cellular telephone network mechanisms to determine the geographical location of the message delivery device 10 as the taxicab 94 moves among the cell site areas 100-103.

In one embodiment, the message sourcing center 12 communicates with the mobile switching center 92 through a public switched telephone network 90. In another embodiment, the message sourcing center 12 transmits directly to the mobile switching center 92 through the cellular network maintained by the mobile switching center 92.

Each of the cell site base stations 110-113 transmits a unique cell site identifier to the cellular telephone receivers contained within the corresponding cell site area during paging operations. The message delivery device 10 extracts the unique cell site identifier and transmits the cell site identifier to the message sourcing center 12 as an indication of the geographical location of the taxicab 94.

The message sourcing center 12 maintains a database of cell site identifiers that correlate to the geographical areas covered by the cell site areas 100-103. The message sourcing center 12 uses the cell site identifier transmitted from the message delivery device 10 to access the cell site identifier database and determine the geographical area of the message delivery device 10. The message selection system 10 uses the geographical area corresponding to the cell site identifier to select a particular message for display on the message delivery device 10.

The geographical locating parameters extracted from a cellular network provide a geographical area resolution that corresponds to the physical dimensions of the individual cell site areas 100-103. The GPS locating system described above provides finer resolution of geographical parameters in comparison to existing cellular telephone networks depending upon the sophistication of the particular GPS receiver employed.

In an alternative embodiment, the functions of the message sourcing center 12 are merged into the mobile switching center 92 that controls the cell site areas 100-103. In this embodiment, the mobile switching center with message sourcing transmits a particular customer defined or generated message to each cell site area 100-103. For example, a particular message is selected for the cell site area 101 and transmitted to all message display devices located within the cell site area 101 via the transmitter 111.

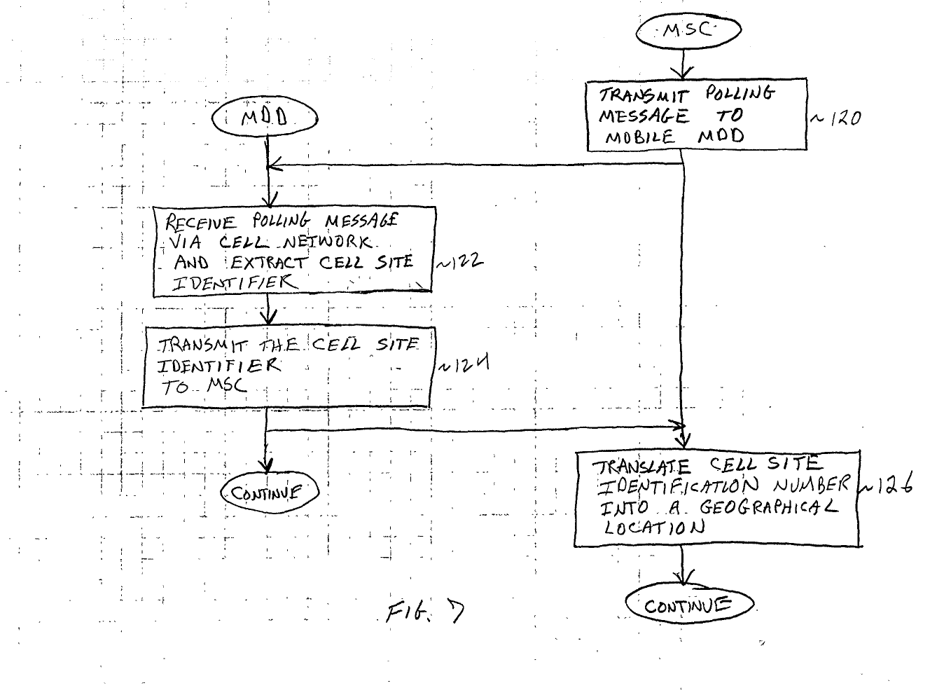

FIG. 7 illustrates a process by which the message sourcing center 12 obtains the geographical location of the message delivery device 10 in an embodiment that employs a cellular telephone network for geographical locating as well as communication. At block 120, the message sourcing center 12 transmits a polling message to the message delivery device 10 attached to the taxicab 94. The polling message is transferred through the public switch telephone network 90 or directly via cellular link and the mobile switching center 92.

The mobile switching center 92 relays the polling message to the message delivery device 10 via the cell site base station 111. The cell site base station 111 encapsulates the polling message in a packet that includes a cell site identifier for the cell site base station 111 and transmits the packet to the message delivery device 10.

At block 122, the message delivery device 10 receives the packet including the polling message from the cell site base station 111 and extracts the cell site identifier contained in the packet. At block 124, the message delivery device 10 transmits the extracted cell site identifier to the message sourcing center 12.

At block 126, the message sourcing center 12 translates the extracted cell site area identifier into geographical parameters covered by the cell site area 101. The geographical location parameters are then used by the message selection system 32 to select from among the messages stored in the message storage system 30 or generate a message using the message generation system which is also part of the storage system 30.

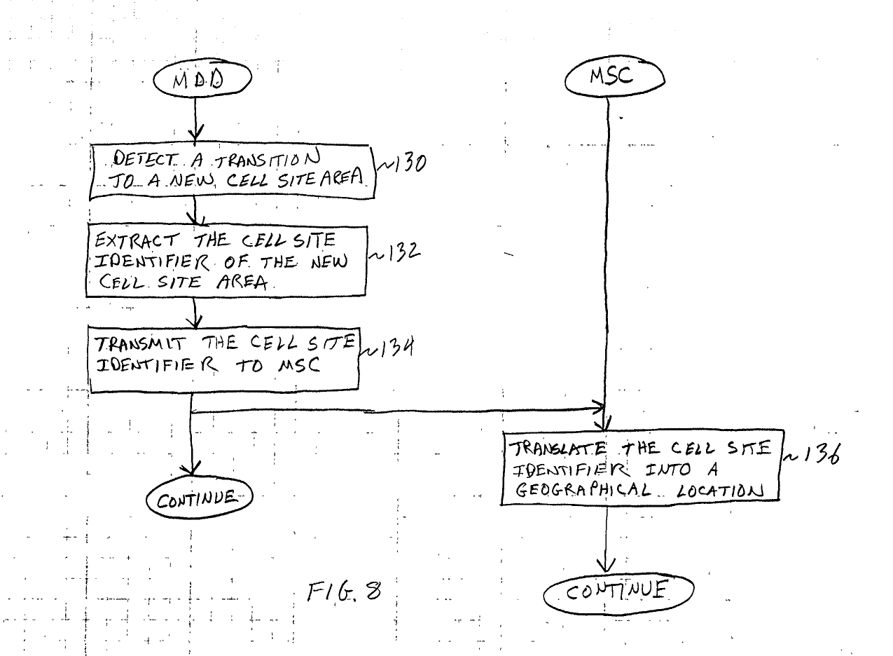

FIG. 8 illustrates another process by which the message sourcing center 12 obtains the geographical location in an embodiment that employs a cellular telephone network for geographical locating.

At block 130, the message delivery device 10 senses a movement of the taxicab 94 to a new cell site area within the cellular network. The message delivery device 10 detects movement to a new cell site area by detecting a change in the cell site identifier received from the cell site base station that covers the geographical location of the taxicab 94. For example, the message delivery device 10 detects a change in cell site identifiers received in paging messages from the cell site base station 111 and cell site base station 113 as the taxicab 94 moves from cell site area 101 into cell site area 103.

At block 132, the message delivery device 10 extracts the new cell site identifier contained in a paging message from the new cell site base station 113. At block 134, the message delivery device 10 transmits the extracted cell site identifier to the message sourcing center 12 via the cell site base station 113 and the mobile switching center 92 and possibly the public switch telephone network 90.

At block 136, the message sourcing center 12 translates the extracted cell site area identifier into geographical parameters covered by the cell site area 103. The geographical location parameters are then used by the message selection system 32 to select from among the messages stored in the message storage system 30 or generate a message using the message generation system which is also part of the storage system 30.

The foregoing detailed description of the present invention is provided for the purposes of illustration and is not intended to be exhaustive or to limit the invention to the precise embodiment disclosed. Accordingly, the scope of the present invention is defined by the appended claims.

What is claimed is:

1. A message system, comprising:
message rendering device;
locating device for determining an indication of geographical location of the message rendering device;
means for selecting a message for the message rendering device from among a set of predefined or generated messages in response to the indication of geographical location and a timing parameter.

2. The message system of claim 1, wherein the message rendering device comprises a device for rendering a visual message.

3. The message system claim 1, wherein the message rendering device comprises a device for rendering an audio message.

4. The message system of claim 1, wherein the means for selecting a message includes a set of selection parameters for each predefined or generated message.

5. The message system of claim 4, wherein the selection parameters include a set of geographical parameters for delivering the corresponding predefined or generated message.

6. The message system of claim 4, wherein the selection parameters include a set of timing parameters for delivering the corresponding predefined or generated message.

7. The message system of claim 1, wherein the message rendering device and the locating device are contained within a mobile message delivery device.

8. The message system of claim 7, wherein the means for selecting or generating a message for the message rendering device from among a set of predefined or generated messages comprises a processor contained in the mobile message delivery device.

9. The message system of claim 7, wherein the means for selecting or generating a message for the message rendering device from among a set of predefined or generated messages is contained in a message sourcing center separate from the mobile message delivery device.

10. The message system of claim 9, further comprising a communication link between the message sourcing center and the mobile message delivery device for transferring the indication of geographical location to the message sourcing center.

11. The message system of claim 10, wherein the message sourcing center transfers the message for the message rendering device to the mobile message delivery device via the communication link.

12. The message system of claim 10, wherein the mobile message delivery device includes a message storage device for holding one or more of the predefined messages.

13. The message system of claim 10, wherein the mobile message delivery device includes a message generation device for generating messages.

14. The message system of claim 12, wherein the message sourcing center transfers one or more of the predefined or generated messages to the mobile message delivery device via the communication link during an off-peak time on the communication link.

15. The message system of claim 14, wherein the mobile message delivery device includes a message generation device for generating messages.

16. The message system of claim 12, wherein the message sourcing center transfers an identifier corresponding to the message for the message rendering device to the mobile message delivery device via the communication link.

17. The message system of claim 16, wherein the mobile message delivery device uses the identifier to retrieve or generate the message for the message rendering device from the message storage device or message generation device.

18. The message system of claim 9, wherein the locating device comprises a global positioning satellite receiver.

19. The message system of claim 18, wherein the communication link comprises a cellular network.

20. The message system of claim 9, wherein the communication link comprises a cellular network.

21. The message system of claim 9, wherein the communication link comprises a temporary hard-wired connection or the physical transference of a removable storage system.

22. The message system of claim 18, wherein the communication link comprises a temporary hard-wired connection or the physical transference of a removable storage system.

23. The message system of claim 20, wherein the locating device comprises a cellular receiver.

24. The message system of claim 23, wherein the indication of geographical location comprises a cell site identifier received by the cellular receiver from a cell site base station that covers a geographical area that includes the mobile message delivery device.

25. The message system of claim 24, wherein the message delivery device transmits the cell site identifier to the message sourcing center in response to a polling message from the message sourcing center.

26. The message system of claim 24, wherein the message delivery device transmits the cell site identifier to the message sourcing center whenever the message delivery device moves between differing cell site areas of the cellular network.

27. The message system of claim 24, wherein the message sourcing center maintains a database for converting the cell site identifier into a geographical location for the corresponding cell site area.

28. The message system of claim 27, wherein the message sourcing center uses the geographical location for the corresponding cell site area to select or generate the message for the message rendering device.

29. The message system of claim 9, wherein the message sourcing center contains a set of selection or generation parameters for each predefined or generated message.

30. The message system of claim 29, wherein the selection or generation parameters include a set of geographical parameters for delivering the corresponding predefined or generated message.

31. The message system of claim 29, wherein the selection or generation parameters include a set of timing parameters for delivering the corresponding predefined or generated message.

32. The message system of claim 9, wherein the message sourcing center maintains a billing information log for holding a set of billing parameters for the message.

33. The message system of claim 32, wherein the billing parameters include the indication of geographical location.

34. The message system of claim 32, wherein the billing parameters include the timing parameter.

35. A message delivery device, comprising:
message rendering device;
locating device for determining an indication of geographical location of the message rendering device;
means for storing a set of selection o generation parameters for each of a set of predefined or generated messages;
means for selecting a message for the message rendering device from among the predefined or generated messages by comparing the indication of geographical location and a timing parameter to the message selection or generation parameters.

36. The message delivery device of claim 35, wherein the message rendering device comprises a device for rendering a visual message.

37. The message delivery device of claim 35, wherein the message rendering device comprises a device for rendering an audio message.

38. The message device of claim 35, wherein the selection parameters for each predefined or generated message include a set of geographical parameters for delivering the corresponding predefined or generated message.

39. The message delivery device of claim 35, wherein the selection or generation parameters for each predefined message include a set of timing parameters for delivering the corresponding predefined or generated message.

40. A message system, comprising:
message sourcing center that transmits a set of message selection generation parameters and a message identifier for each of a set of predefined or generated messages;
at least one message delivery device each having a message rendering device and a locating device for determining an indication of geographical location of the message delivery device, each message delivery device having means for storing the predefined or generating messages and means for selecting or generating a message for the message rendering device from among the predefined or generated messages by comparing the indication of geographical location and a timing parameter to the message selection or generation parameters.

41. The message system of claim 40, wherein the message rendering device comprises a device for rendering a visual message.

42. The message system of claim 40, wherein the message rendering device comprises a device for rendering an audio message.

43. The message system of claim 40, wherein the selection or generation parameters for each predefined or generated message include a set of geographical parameters for delivering the corresponding predefined or generated message.

44. The message system of claim 40, wherein the selection or generation parameters for each predefined or generated message include a set of timing parameters for delivering the corresponding predefined or generated message.
